(19) United States
(12) Patent Application Publication
(10) Pub. No.: US 2011/0012933 A1
(43) Pub. Date: Jan. 20, 2011

(54) DISPLAY DEVICE WITH AUTOMATIC BRIGHTNESS ADJUSTMENT AND METHOD FOR OPERATING THE SAME

(75) Inventor: Bomin WENG, Sanchong City (TW)

Correspondence Address: VOLPE AND KOENIG, P.C., UNITED PLAZA, 30 SOUTH 17TH STREET, PHILADELPHIA, PA, 19103, US

(73) Assignee: HANNSTAR DISPLAY CORPORATION LTD., Taipei City (TW)

(21) Appl. No.: 12/748,983

(22) Filed: Mar. 29, 2010

(30) Foreign Application Priority Data
Jul. 14, 2009 (TW) 098123822

(51) Int. Cl. G09G 5/10; G09G 3/36

(52) U.S. Cl. 345/690; 345/102

(57) ABSTRACT

A display device is provided. The display device includes a system module detecting an image signal and outputting a first frequency in response thereto, wherein the first frequency is adjusted to a second frequency when the image signal is switched.

### FIELD OF THE INVENTION

The present invention relates to a device with brightness adjustment, and more particularly to a display device with automatic brightness adjustment.

### BACKGROUND OF THE INVENTION

In recent years, the flat panel display has replaced the traditional CRT display to become the mainstream of the display due to its advantages of small size, low radiation and low power consumption. The flat panel display mainly includes a backlight module and a panel. The panel includes conductive glass, liquid crystals, an alignment layer, a polarizer, a driver, etc. The backlight module is used for illuminating the panel to display the image. The backlight module includes a cold cathode fluorescent lamp (CCFL), a light guide plate, an inverter, various kinds of optical films, etc. The inverter provides power to the backlight module, and the CCFL is driven by the pulse generated by the inverter. The internal light source is a key factor in deciding the brightness and tint of the flat panel display.

With the population of the digital TV, the flat panel display is also widely applied thereto. The image signal received by the traditional CRT display is an AV signal. However, the digital TV can receive much more image signals than the traditional CRT display, e.g. an HDMI signal, a DTV signal, a TV signal, a VGA signal, an AV signal, a YPbPr signal, an SCART signal, etc. The user usually uses an LCD TV to connect to a plurality of image output devices to receive a plurality of image signals. For example, the image output device can be a DVD player, a PC or an HDMI device. Nevertheless, since the respective image signals of the image output devices are different from each other, the brightness measured on the LCD will vary with different image signal sources. Additionally, it is desirable that the brightness of the LCD can maintain a standard brightness when switching different image signal sources.

In order to overcome the drawbacks in the prior art, a display device with automatic brightness adjustment and the method for operating the same are provided. The particular designs in the present invention not only solve the problems described above, but also are easy to be implemented. Thus, the present invention has the utility for the industry.

### SUMMARY OF THE INVENTION

It is an object of the present invention to maintain the brightness of the LCD at a standard brightness when the user selects different image signal sources.

In accordance with one aspect of the present invention, a display device is provided. The display device comprises a system module detecting an image signal and outputting a first frequency in response thereto, wherein the first frequency is adjusted to a second frequency when the image signal is switched.

Preferably, the system module further comprises a controller including a signal sensor and a memory.

Preferably, the image signal comprises one selected from a group consisting of an HDMI, a DTV, a TV, a VGA, an AV, a YPbPr and an SCART signals.

Preferably, the display device further comprises a display receiving a driving signal to generate an image having a first brightness, and including a panel receiving the driving signal to display the image; and an internal light source serving as a backlight of the display to provide the first brightness; and a light source adjusting module outputting a driving pulse to the internal light source in response to the first frequency for adjusting the first brightness to a second brightness.

Preferably, the light source adjusting module is operated in a burst mode.

Preferably, when the image signal is an HDMI signal and the first brightness is 300 cd/m², the first frequency is 220 Hz and the first brightness of 300 cd/m² is serving as the second brightness.

Preferably, when the image signal is switched to an SCART signal and the first brightness is 290 cd/m², the first frequency is adjusted to the second frequency at 230 Hz for adjusting the first brightness of 290 cd/m² to the second brightness of 300 cd/m².

Preferably, the display device is a liquid crystal display device, and the internal light source is a fluorescent tube.

Preferably, the display device is a rear projection display device, and the internal light source is a fluorescent tube.

Preferably, the display device is a projection device, and the internal light source is a fluorescent tube.

In accordance with another aspect of the present invention, a system module is provided. The system module outputs a first frequency in response to an image signal, wherein the first frequency is adjusted to a second frequency when the image signal is switched.

Preferably, the system module further comprises a controller including a signal sensor and a memory.

Preferably, the image signal comprises one selected from a group consisting of an HDMI, a DTV, a TV, a VGA, an AV, a YPbPr and an SCART signals.

Preferably, the system module is used for a display device, the display device has an image having a first brightness, and the first brightness is adjusted to a second brightness when the first frequency is adjusted to the second frequency.

Preferably, when the image signal is an HDMI signal and the first brightness is 300 cd/m², the first frequency is 220 Hz and the first brightness of 300 cd/m² is serving as the second brightness.

Preferably, when the image signal is switched to an SCART signal and the first brightness is 290 cd/m², the first frequency is adjusted to the second frequency at 230 Hz for adjusting the first brightness of 290 cd/m² to the second brightness of 300 cd/m².

In accordance with a further aspect of the present invention, a method for operating a display device is provided. The method comprises steps of (a) detecting an image signal; (b) outputting a first frequency in response to the image signal; and (c) adjusting the first frequency to a second frequency when the image signal is switched.

Preferably, the method further comprises the following sub-steps after the step (a): (a1) receiving the image signal; (a2) outputting a driving signal based on the image signal; (a3) receiving the driving signal; and (a4) displaying an image having a first brightness based on the driving signal.

Preferably, the method further comprises the following sub-step after the step (c): (c1) adjusting the first brightness to a second brightness in response to the second frequency.

Preferably, the image signal comprises one selected from a group consisting of an HDMI, a DTV, a TV, a VGA, an AV, a YPbPr and an SCART signals.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows the brightness adjusting apparatus according to a preferred embodiment of the present invention;

FIG. 2(a) shows the discontinuous pulse having a first frequency;

FIG. 2(b) shows the driving pulse having a first frequency;

FIG. 3 shows the brightness adjusting apparatus according to another preferred embodiment of the present invention;

FIG. 4(a) shows the discontinuous pulse having a second frequency;

FIG. 4(b) shows the driving pulse having a second frequency; and

FIG. 5 shows a method for operating the display device with automatic brightness adjustment.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

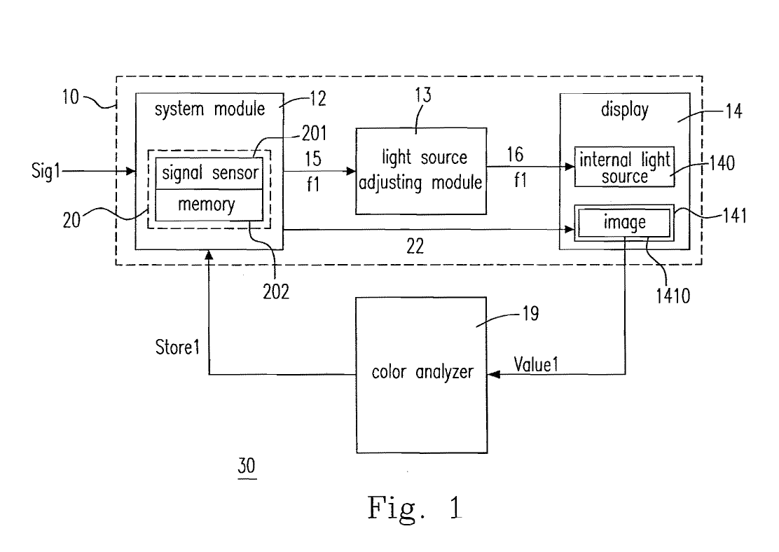

Please refer to FIG. 1, which shows the brightness adjusting apparatus 30 according to a preferred embodiment of the present invention. The brightness adjusting apparatus 30 includes a display device with automatic brightness adjustment 10 and a color analyzer 19. The display device with automatic brightness adjustment 10 includes a system module 12, a light source adjusting module 13 and a display 14. The system module 12 includes a controller 20, and the controller 20 includes a signal sensor 201 and a memory 202. The display 14 includes an internal light source 140 and a panel 141 for displaying an image 1410. The panel 141 receives a driving signal 22 to display the image 1410. The internal light source 140 serves as the backlight of the display 14 to provide the brightness of the image 1410. The light source adjusting module 13 is used for adjusting the brightness of the image 1410. The color analyzer 19 can measure the brightness and saturation. In this embodiment, the color analyzer 19 is used for measuring the brightness of the image 1410. The system module 12 adjusts the brightness of the image 1410 to a standard brightness based on the measured brightness.

Firstly, the system module 12 receives an image signal Sig1 and outputs a discontinuous pulse 15 having a first frequency f1. The light source adjusting module 13 receives the discontinuous pulse 15 having the first frequency f1, and outputs a driving pulse 16 for driving the internal light source 140. The image signal Sig1 is an HDMI signal, a DTV signal, a TV signal, a VGA signal, an AV signal, a YPbPr signal or an SCART signal, but is not limited thereto. The image signal Sig1 at least includes the saturation, brightness and horizontal/vertical synchronizing signals of the image signal Sig1. For example, “Y” in the YPbPr signal represents the brightness, “Pb” therein represents blue, and “Pr” therein represents red. The three primary colors of the white light are mixed by red, green and blue. Therefore, the green light can be obtained by removing the blue light and red light from the white light. Hence, the green light signal is unnecessary to be sent when sending the image signal Sig1. However, the AV signal is a signal mixed by the saturation, brightness and horizontal/vertical synchronizing signals. When the image signal Sig1 is the AV signal and demodulated by the system module 12, the brightness of the image signal Sig1 will be declined. Accordingly, different image signals Sig1 will result in different brightness.

The brightness of the image 1410 is adjusted when producing the product. Before adjustment, an external device (not shown) which can output various image signals Sig1, or different external devices which can output different image signals Sig1 respectively, need to be prepared. Image files with a blank frame can be pre-stored in the external device. Whether the brightness of the blank frame conforms to a standard brightness is measured by a vector oscilloscope. The image file with a blank frame which conforms to the standard brightness is selected to be the basis of brightness adjustment. Through using the selected image file, the external device outputs the image signal Sig1 whose brightness is the standard brightness. The system module 12 receives the image signal Sig1, and the brightness measured on the image 1410 is about 250 cd/m² to 350 cd/m², depending on the sources of the image signal Sig1. If the brightness of 300 cd/m² is to serve as the standard brightness, the gradation and brightness contrast of the image will be optimal. After the image signal Sig1 is input to the system module 12, the color analyzer 19 is used to measure the brightness of the image 1410. Then, the first frequency f1 of the discontinuous pulse 13 is adjusted to a second frequency f2 based on the measured first brightness Value1.

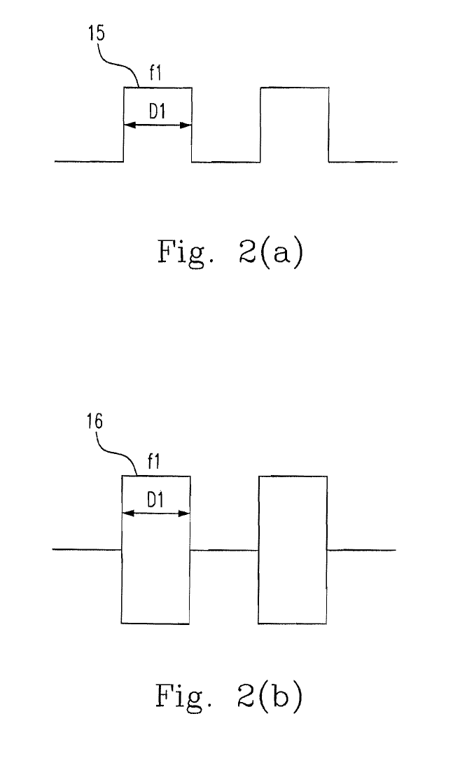

Please refer to FIG. 2(a), which shows the discontinuous pulse 15 having a first frequency f1, wherein D1 represents the pulse width of the discontinuous pulse 15. In FIG. 1, the system module 12 outputs the discontinuous pulse 15 having the first frequency f1 in response to the image signal Sig1. Please refer to FIG. 2(b), which shows the driving pulse 16 having a first frequency f1. The light source adjusting module 13 outputs the driving pulse 16 to the internal light source 140 in response to the discontinuous pulse 15 having the first frequency f1 so as to adjust the brightness of the image 1410. The light source adjusting module 13 is operated in a burst mode. The main function of the light source adjusting module 13 is to increase the amplitude of the discontinuous pulse 15 and output the driving pulse 16, wherein the driving signal 16 has the first frequency f1.

In FIG. 1, a preferred embodiment is that when the image signal Sig1 is the HDMI signal, the color analyzer 19 measures the brightness of the image 1410 to obtain a first brightness Value1 of 300 cd/m², and the first frequency f1 of the discontinuous pulse 15 is 220 Hz. The first frequency f1 and a first code A are stored in the system module 12 to be a first set of corresponding values Store 1. The first code A represents that the image signal Sig1 is the HDMI signal and the first frequency f1 is 220 Hz.

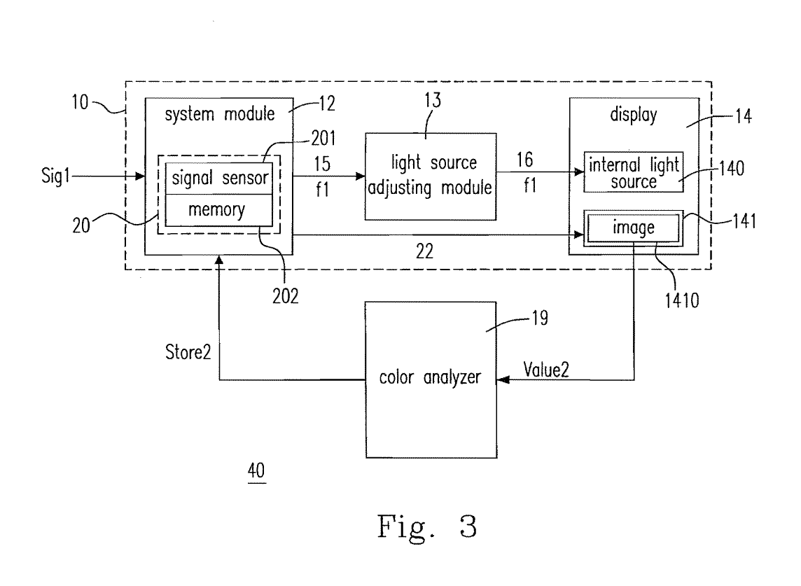

Please refer to FIG. 3, which shows the brightness adjusting apparatus 40 according to another preferred embodiment of the present invention. The brightness adjusting apparatus 40 includes a display device with automatic brightness adjustment 10 and a color analyzer 19. The display device with automatic brightness adjustment 10 includes a system module 12, a light source adjusting module 13 and a display 14. The system module 12 includes a controller 20, and the controller 20 includes a signal sensor 201 and a memory 202. The display 14 includes an internal light source 140 and a panel 141 for displaying an image 1410. The panel 141 receives a driving signal 22 to display the image 1410. The internal light source 140 serves as the backlight of the display 14 to provide the brightness of the image 1410. The light source adjusting module 13 is used for adjusting the brightness of the image 1410. When the image signal Sig1 is the SCART signal, the color analyzer 19 measures the image 141 to obtain a second brightness Value2 of 290 cd/m², and the first frequency f1 of the discontinuous pulse 15 is 220 Hz. The system module 12 uses the controller 20 to adjust the first frequency f1 to the second frequency f2, 230 Hz. The driving pulse 16 of the second frequency f2 adjusts the brightness of the image 1410 to the standard brightness. At this time, the second frequency f2 and a second code B are stored in the system module 12 to be a second set of corresponding values Store2. The second code B represents that the image signal Sig1 is the SCART signal and the second frequency f2 is 230 Hz. Please refer to Table 1, which shows the first set of corresponding values Store 1 and the second set of corresponding values Store2. The row without code represents that the brightness of the image 1410 does not reach the standard brightness yet, so that it needs to be adjusted.

TABLE 1

| | Source of the | Frequency of the | |
|---|---|---|---|
| Code | image signal | discontinuous pulse | Brightness |
| A | HDMI | f1 = 220 Hz | 300 cd/m² |
| | SCART | f1 = 220 Hz | 290 cd/m² |
| B | SCART | f2 = 230 Hz | 300 cd/m² |

The first code A represents that the image signal Sig1 is the HDMI signal and the first brightness Value1 is 300 cd/m². In this case, the first brightness Value1 has reached the standard brightness, so that the first frequency f1 of the discontinuous pulse 15 does not need to be adjusted. When the image signal Sig1 is the SCART signal, since the second brightness Value2 measured by the color analyzer 19 is only 290 cd/m2, the system module 12 uses the controller 20 to adjust the first frequency f1, 220 Hz, of the driving pulse 15 to the second frequency, 230 Hz. Similarly, other image signals Sig1 are also adjusted according to the above-mentioned method. The system module 12 stores plural sets of corresponding values. Hence, when different image signals Sig1 are input to the system module 12, the frequency of the discontinuous pulse 15 can be adjusted based on the plural sets of corresponding values to enable the brightness of the image 1410 to reach the standard brightness.

The system module 12 processes the image signal Sig1, and then outputs the driving signal 22 to the panel 141 to drive it to display the image 1410. The driving signal 22 includes horizontal/vertical synchronizing signals (not shown), a control signal (not shown) and a liquid crystal driving signal (not shown). The liquid crystal driving signal includes a row-driving liquid crystal signal (Vcom) and a column-driving liquid crystal signal (Vseg).

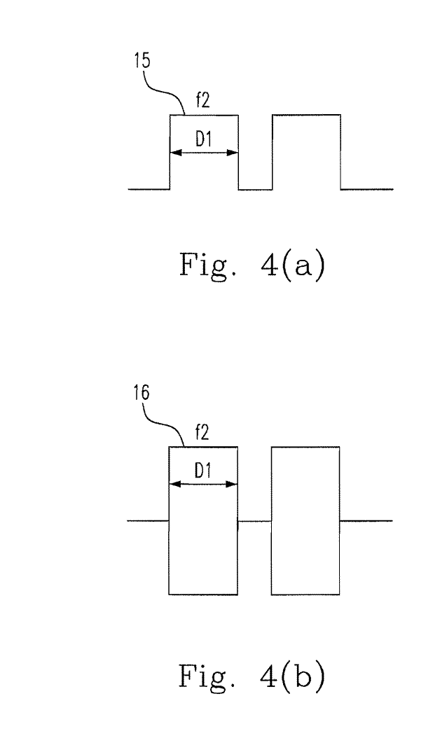

Please refer to FIG. 4(a), which shows the discontinuous pulse having a second frequency. In FIG. 4(a), when the first frequency f1 is adjusted to the second frequency f2, according to this embodiment, the second frequency f2 is enhanced from 220 Hz to 230 Hz, but the pulse width D1 of the discontinuous pulse 15 is not changed. Therefore, the turn-off period of the discontinuous pulse 15 is shortened. Please refer to FIG. 4(b), which shows the driving pulse having a second frequency. The light source adjusting module 13 outputs the driving pulse 16 in response to the discontinuous pulse 15 having the second frequency f2 of 230 Hz. The frequency of the driving pulse 16 is the second frequency f2, and the pulse width D1 of the driving pulse 16 is not changed. Hence, the turn-off period of the driving pulse 16 is shortened. This enables the turn-off period of the internal light source 140 controlled by the driving pulse 16 to be shortened. Accordingly, the brightness of the internal light source 140 will be enhanced, which enables the brightness of the image 141 to reach the standard brightness.

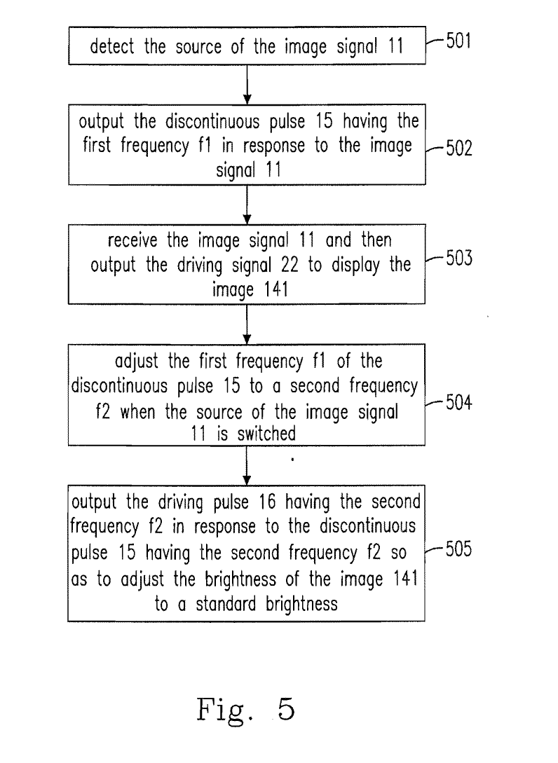

Please refer to FIG. 5, which shows a method for operating the display device with automatic brightness adjustment. In step 501, the system module 12 detects the source of the image signal 11. In step 502, the system module 12 outputs the discontinuous pulse 15 having the first frequency f1 in response to the image signal 11. In step 503, the system module 12 receives the image signal 11 and then outputs the driving signal 22 to display the image 141. In step 504, when the source of the image signal 11 is switched, the system module 12 uses the controller 20 to adjust the first frequency f1 of the discontinuous pulse 15 to a second frequency f2. In step 505, the light source adjusting module 13 outputs the driving pulse 16 having the second frequency f2 to the internal light source 140 in response to the discontinuous pulse 15 having the second frequency f2 so as to adjust the brightness of the image 141 to a standard brightness.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a system module detecting an image signal and outputting a first frequency in response thereto, wherein the first frequency is adjusted to a second frequency when the image signal is switched.

2. A display device as claimed in claim 1, wherein the system module further comprises a controller including a signal sensor and a memory.

3. A display device as claimed in claim 1, wherein the image signal comprises one selected from a group consisting of an HDMI, a DTV, a TV, a VGA, an AV, a YPbPr and an SCART signals.

4. A display device as claimed in claim 1, further comprising:
a display receiving a driving signal to generate an image having a first brightness, and including:
a panel receiving the driving signal to display the image; and
an internal light source serving as a backlight of the display to provide the first brightness; and
a light source adjusting module outputting a driving pulse to the internal light source in response to the first frequency for adjusting the first brightness to a second brightness.

5. A display device as claimed in claim 4, wherein the light source adjusting module is operated in a burst mode.

6. A display device as claimed in claim 4, wherein when the image signal is an HDMI signal and the first brightness is 300 cd/m², the first frequency is 220 Hz and the first brightness of 300 cd/m² is serving as the second brightness.

7. A display device as claimed in claim 6, wherein when the image signal is switched to an SCART signal and the first brightness is 290 cd/m², the first frequency is adjusted to the second frequency at 230 Hz for adjusting the first brightness of 290 cd/m² to the second brightness of 300 cd/m².

8. A display device as claimed in claim 1, wherein the display device is a liquid crystal display device, and the internal light source is a fluorescent tube.

9. A display device as claimed in claim 1, wherein the display device is a rear projection display device, and the internal light source is a fluorescent tube.

10. A display device as claimed in claim 1, wherein the display device is a projection device, and the internal light source is a fluorescent tube.

11. A system module, outputting a first frequency in response to an image signal, wherein the first frequency is adjusted to a second frequency when the image signal is switched.

12. A system module as claimed in claim 11, further comprising a controller including a signal sensor and a memory.

13. A system module as claimed in claim 11, wherein the image signal comprises one selected from a group consisting of an HDMI, a DTV, a TV, a VGA, an AV, a YPbPr and an SCART signals.

14. A system module as claimed in claim 11, wherein the system module is used for a display device, the display device has an image having a first brightness, and the first brightness is adjusted to a second brightness when the first frequency is adjusted to the second frequency.

15. A system module as claimed in claim 14, wherein when the image signal is an HDMI signal and the first brightness is 300 cd/m², the first frequency is 220 Hz and the first brightness of 300 cd/m² is serving as the second brightness.

16. A system module as claimed in claim 14, wherein when the image signal is switched to an SCART signal and the first brightness is 290 cd/m², the first frequency is adjusted to the second frequency at 230 Hz for adjusting the first brightness of 290 cd/m² to the second brightness of 300 cd/m².

17. A method for operating a display device, comprising steps of:
(a) detecting an image signal;
(b) outputting a first frequency in response to the image signal; and
(c) adjusting the first frequency to a second frequency when the image signal is switched.

18. A method as claimed in claim 17, further comprising the following sub-steps after the step (a):
(a1) receiving the image signal;
(a2) outputting a driving signal based on the image signal;
(a3) receiving the driving signal; and
(a4) displaying an image having a first brightness based on the driving signal.

19. A method as claimed in claim 18, further comprising the following sub-step after the step (c):
(c1) adjusting the first brightness to a second brightness in response to the second frequency.

20. A method as claimed in claim 17, wherein the image signal comprises one selected from a group consisting of an HDMI, a DTV, a TV, a VGA, an AV, a YPbPr and an SCART signals.
